(19) United States
(12) Patent Application Publication
(10) Pub. No.: US 2008/0156788 A1
(43) Pub. Date: Jul. 3, 2008

(54) Insulation jacket for a baking oven

(76) Inventor: Michael Edward Hubbs, Berlin Center, OH (US)

Correspondence Address: SAND & SEBOLT, AEGIS TOWER, SUITE 1100, 4940 MUNSON STREET, NW, CANTON, OH, 44718-3615, US

(21) Appl. No.: 11/649,043

(22) Filed: Jan. 3, 2007

(51) Int. Cl. A21B 1/00

(52) U.S. Cl. 219/405

(57) ABSTRACT

A unitary-formed insulation jacket molded to be slidingly engaged around an exterior surface of a conventional baking oven muffle and a method of manufacturing the same. The insulation jacket is vacuum-formed from a slurry that includes high temperature refractory fibers, organic and inorganic binders and filler materials. The insulation jacket has a top wall, a bottom wall, opposing side walls and a rear wall that are substantially continuous and free of joints with each other. The top, bottom, sides and rear walls surround and define an interior cavity which is complementary shaped and sized to tightly fit around the exterior surface of the oven muffle. The walls of the insulation jacket are formed so as to be between ¼ inch and 2 inches thick and preferably are all 1 inch thick. The jacket may be provided with openings in any one of the walls which are complementary positioned to receive components, such as wiring that extends outwardly away from the exterior surface of the muffle, therethrough.

### BACKGROUND OF THE INVENTION

1. Technical Field

This invention generally relates to large appliances. More particularly, the invention relates to convection ovens. Specifically, the invention relates to a unitary-formed insulation jacket that vacuum-formed from a slurry of high temperature refractory fibers and binders; and is slidably engageable around an oven muffle of a conventional baking oven to insulate the same.

2. Background Information

Conventional baking ovens are provided with insulation to both hold in the heat generated by the heating elements in the oven cavity and to prevent damage and possible fires in the surrounding fixtures in the kitchen. This insulation is typically applied in the form of an insulation blanket that is wrapped around the back, sides, top and bottom of an oven muffle and is secured in place by a fire-resistant strap. The insulated oven muffle is then installed within a cavity in a standard-sized housing and a door is affixed to the housing to allow access into the muffle cavity.

The insulation blanket typically has to be around 3″ thick in order to insulate the oven to a satisfactory degree. However, even with this thickness of insulation applied around the oven, the loss of heat into the surroundings can be fairly substantial. This loss of heat results in a longer initial warm-up time for the oven and requires that the heating elements be generating heat for a longer period of time in order to maintain any specific temperature within the oven cavity. Finally, the thickness of the insulation has to be taken into account when designing the oven muffle as the box and insulation are received within an industry standard sized outer shell.

Various patents have addressed the issues associated with using insulating blankets. For example, U.S. Pat. No. 6,080,966 issued to Mallinger et al, discloses an oven muffle which includes inner and outer walls with a particulate material disposed in the gap formed between them. The outer walls are pre-tensioned toward the inner walls so as to exert pressure on the particulate material and thereby keep it in place as the temperature in the oven cavity changes. The particulate matter used are balls or beads of perlite, diatomaceous earth or swelling clay.

U.S. Pat. No. 6,392,203 issued to Schmidmayer, discloses an oven muffle that includes an insulating protective layer that is extremely thin and that has heating elements applied therein by thick-film technology. The oven muffle is then embedded in muffle insulation such as perlite that is only 0.4 mm thick.

There is therefore a need in the art for insulation for conventional baking ovens that insulates more effectively, reduces initial warm-up time, reduces the amount of electricity or gas used to maintain a particular temperature within the oven cavity and that allows for the production of larger oven “boxes” for use within industry standard sized outer shells.

### SUMMARY OF THE INVENTION

The present invention comprises a unitary-formed insulation jacket molded to be slidingly engaged around an exterior surface of a conventional baking oven muffle and a method of manufacturing the same. The insulation jacket is vacuum-formed from a slurry that includes high temperature refractory fibers, organic and inorganic binders and optional filler materials. The insulation jacket has a top wall, a bottom wall, opposing side walls and a rear wall that are substantially continuous and free of joints with each other. The top, bottom, sides and rear walls surround and define an interior cavity which is complementary shaped and sized to tightly fit around the exterior surface of the oven muffle. The walls of the insulation jacket are formed so as to be between ¼ inch and 2 inches thick and preferably are all 1 inch thick. The jacket may be provided with openings in any one of the walls which are complementary positioned to receive components, such as wiring that extends outwardly away from the exterior surface of the muffle, therethrough.

### BRIEF DESCRIPTION OF THE DRAWINGS

The preferred embodiments of the invention, illustrative of the best mode in which applicant has contemplated applying the principles, are set forth in the following description and are shown in the drawings and are particularly and distinctly pointed out and set forth in the appended claims.

FIG. 1 is a perspective view of a conventional baking oven;

FIG. 2 is an exploded view of the oven with the door removed and showing the housing separated from the insulating jacket enclosed oven muffle;

FIG. 3 is a further exploded perspective view of the oven muffle and the insulating jacket separated from each other;

FIG. 4 is a front view of the oven muffle with the insulating jacket surrounding the same; and

FIG. 5 is a side view of the oven muffle and insulating jacket through line 5-5 of FIG. 4.

### DETAILED DESCRIPTION OF THE INVENTION

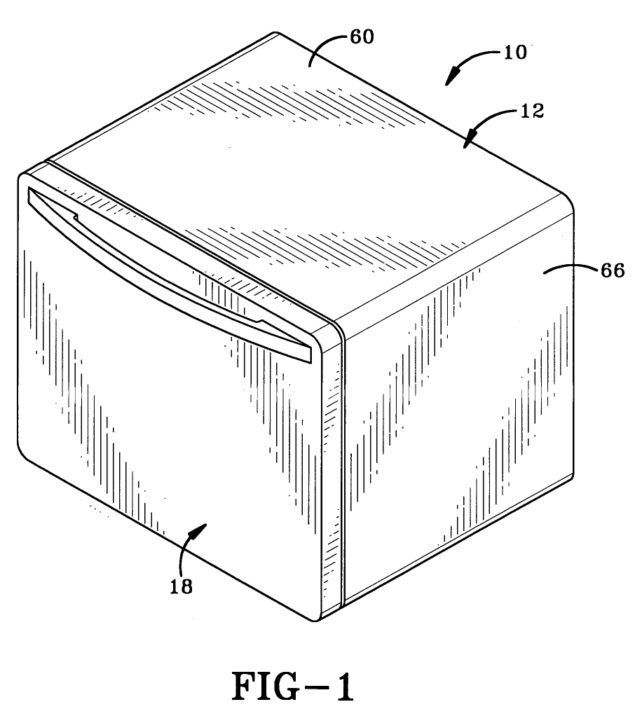

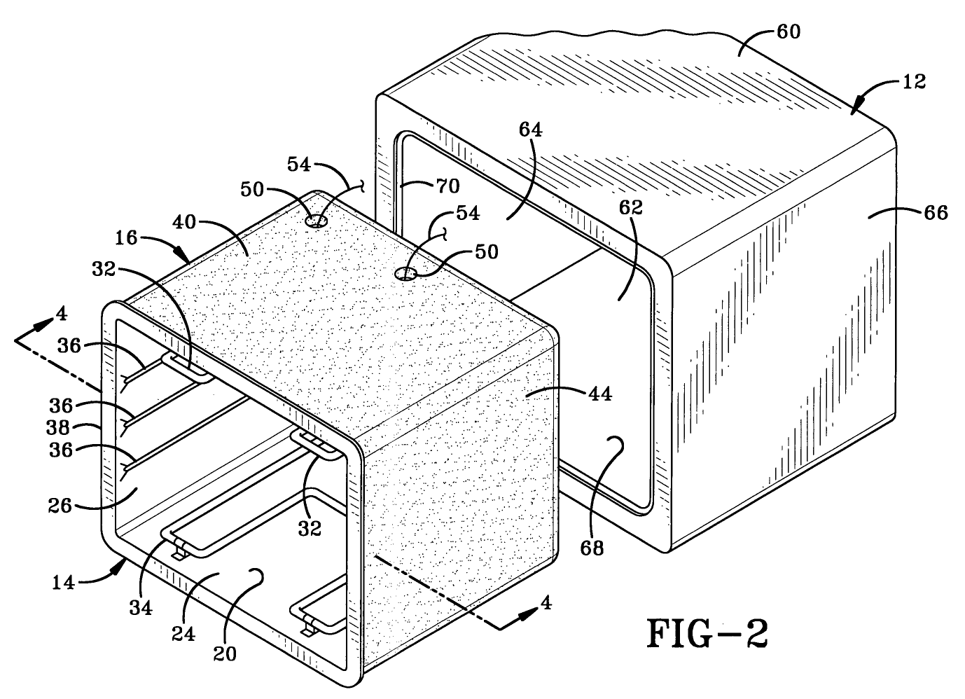

Referring to FIGS. 1-5, there is shown a baking oven 10 which includes an outer housing 12, a muffle 14 and an insulating jacket in accordance with the present invention and generally indicated at 16. A door 18 is provided on housing 12 to limit access to the interior cavity 20 of the muffle 14.

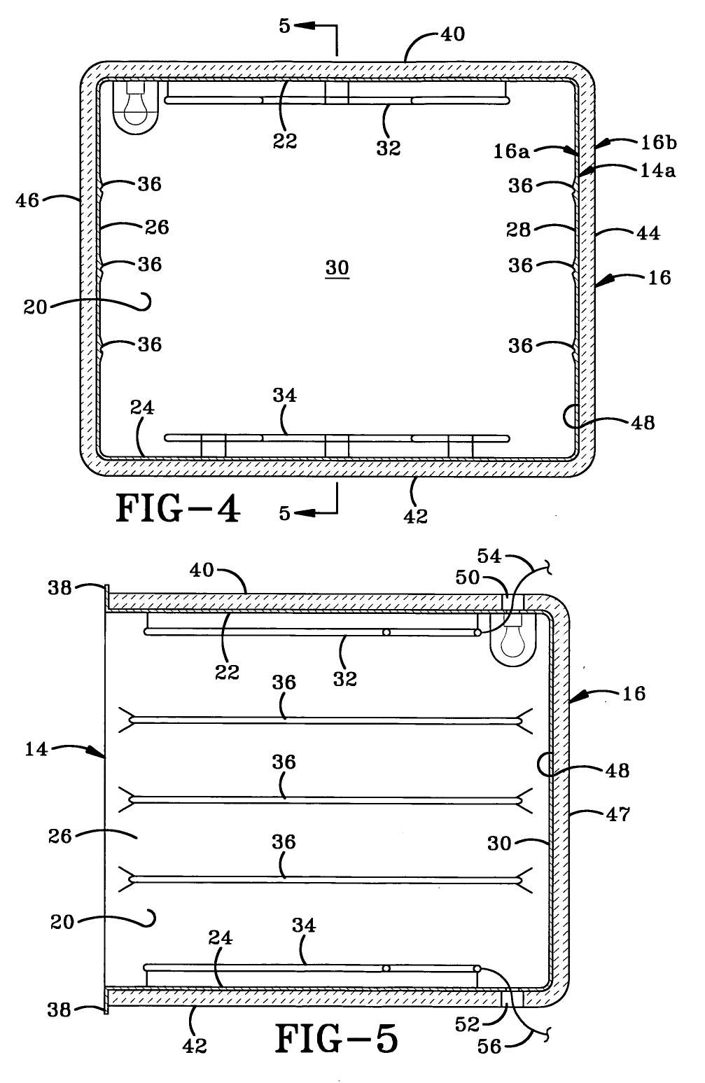

Muffle 14 comprises a top wall 22, a bottom wall 24, side walls 26, 28 and a rear wall 30 (FIG. 5) that surround and define cavity 20. Upper and lower heating elements 32, 34 are installed within cavity 20 and a plurality of shelf supports 36 are formed on the interior surfaces of side walls 26, 28. Shelf supports 36 are designed to support shelves (not shown) within cavity 20 and foodstuffs are positionable upon the shelves for cooking. Heat generated by heating elements 32, 34 will heat the air within cavity 20 and cook or warm any foodstuffs placed upon the shelves. A flange 38 is provided around the forward edges of top, bottom and side walls 22, 24, 26, 28 to provide a sealing surface against which door 18 can close.

In accordance with a specific feature of the present invention, an insulating jacket 16 is provided to insulate and retain heat within muffle 14. Jacket 16 comprises any one or more of a variety of different types of insulating materials, such as fiberglass, mineral wool, refractory ceramic fiber (RCF), body soluble fiber (Non-RCF), silica fiber, mullite, or any other low density insulation material that ranges from 1 pound per cubic foot to 20 pounds per cubic foot. Materials that fall outside this range may, however, also be utilized without departing from the spirit of the present invention.

Jacket 16 preferably is manufactured by forming a slurry of liquid and high-temperature refractory ceramic or mineral fibers, binder materials and optional fillers. The slurry is placed in a mold and then vacuum-formed to remove the liquid and to thereby form the desired shape. The typical percentage of solids (solids in water by weight %) is 0.25%-5%. The mold in question is one that has the shape of the exterior surface of oven muffle 14. The so-formed insulation jacket 16 is an integrally-formed, unitary component that is free of joint type connections between the various wall surfaces.

The slurry includes a solid component that is made up from fibers, binders and, if needed, filler materials. The fiber portion of the slurry is comprised of high-temperature refractory ceramic and/or mineral fibers comprising oxides of aluminum, silicon, calcium and magnesium. The fiber portion constitutes between 35% and 90% of the solids in the slurry.

The slurry further includes one or more of organic and inorganic binders. The organic binders preferably are cationic starch, cationic polymers or polymeric resins of phenol-formaldehyde. The organic binders constitute between 3% and 7% of the solids in the slurry. The inorganic are colloidal silica or colloidal alumina that constitute between 3% and 25% of the solids in the slurry.

The ceramic fillers which may be added to adjust the slurry to the desired density are selected from oxides of aluminum, silicon, calcium, magnesium that have particle sizes passing through a 30 mesh sieve. The ceramic fillers may constitute between 0% and 60% of the solids in the slurry.

The most desired formulation for the solid portion of the slurry is:
Ceramic Fibers comprising Alumina 42%-45% and Silica 55%-58%; together constituting 90% of the solids in the slurry;
Cationic Starch constituting 5% of the solids in the slurry
Colloidal Silica constituting 5% of the solids in the slurry.

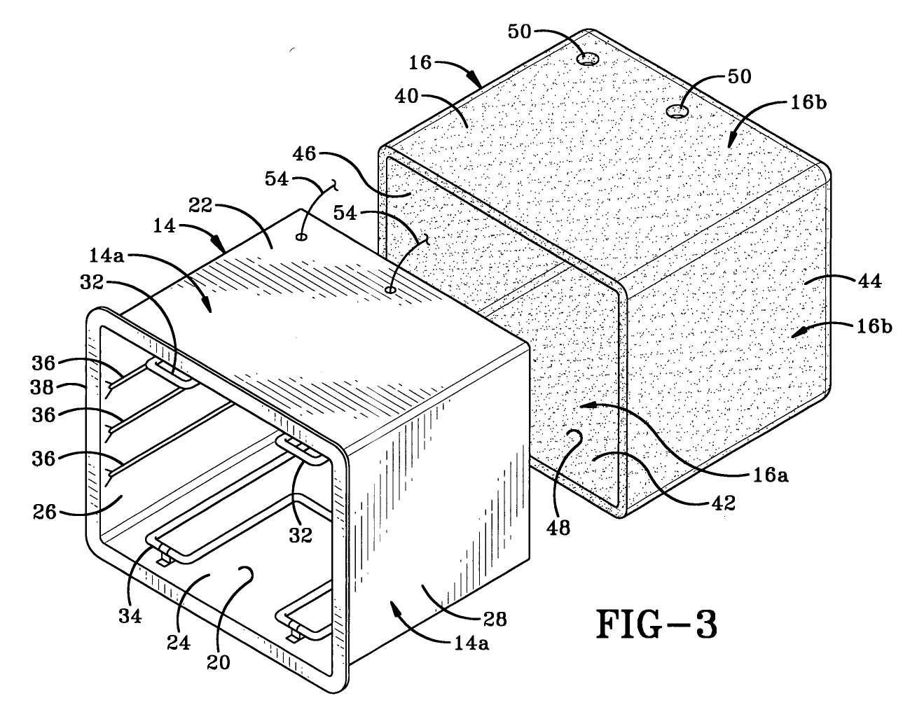

Referring to FIG. 3, through vacuum-forming, the above-named materials are formed into a generally cube-shaped insulating member that has a top wall 40, a bottom wall 42, side walls 44, 46 and a rear wall 47. These walls are substantially continuous and free of joints. The walls define and surround an interior cavity 48 that is complementary sized and shaped to fit tightly around the exterior surface 14a of muffle 14. Jacket 16 may be formed with openings 50, 52 (FIG. 5) through which the electrical wires 54, 56 from upper and lower heating elements 32, 34 can pass. Openings 50, 52 are formed in any one of top, bottom, side and rear walls of jacket 16 that are needed to receive projecting components from muffle 14 therethrough. As such, openings 50, 52 are complementary located with the relevant components and are appropriately sized to tightly receive the same therethrough.

In accordance with a specific feature of the present invention, top, bottom, side and rear walls 40, 42, 44, 46 are all formed so that they are between ¼ inch and 2 inches thick. Preferably all of the walls are 1 inch thick. The thickness of all of the walls is also preferably substantially uniform throughout the entire jacket 16.

It will be understood that while jacket 16 is disclosed as comprised of a mixture of fibers, binders and fillers, additional materials may be added to enhance the properties of jacket 16, without departing from the spirit of the present invention. So, for instance, water repellant substances may be incorporated into the slurry or applied to the interior 16a or exterior surfaces 16b of jacket 16 to improve the water resistance of the insulating material.

A conventional baking oven may be assembled by placing oven muffle 14 within interior cavity 48 of insulation jacket 16. Housing 12 is then applied around the muffle/jacket combination. Housing 12 comprises an upper panel 60, lower panel 62, side panels 64, 66 and a rear panel (not shown). These panels surround and define an interior cavity 68 that is sized to receive the muffle/jacket combination therein. Flange 38 on muffle 14 abuts an interior flange 70 on housing 12, thereby providing a sealed entrance to oven 10. Muffle 14 and housing 12 may be secured together with fasteners (not shown) that extend through flanges 38, 70.

Tests were conducted to determine the difference between previously used types of oven insulation and that of the present invention. A first test was conducted on a conventional baking oven insulated with 3″ of TRS-10 OC insulation, this being a blanket-type insulation manufactured by Owens-Corning Fiberglas Technology Inc. of Summit, Ill. The oven was heated to a temperature of 500° F. for 20 minutes and then the temperature inside and outside the oven was measured. The inside oven temperature was found to be, as expected, 500° F., while the outside temperature, which was measured proximate the external surface of the insulation at the back of the oven, was found to be 148° F.

By contrast, a substantially identical test was conducted on a conventional baking over that was insulated with an insulation jacket of the present invention, except for the fact that the test was conducted for a longer period of time, that being two hours instead of 20 minutes. The inside oven temperature after two hours was found to be 500° F., while the outside oven temperature, measured proximate the external surface of the insulation at the back of the oven, was 92° F. The use of the insulation jacket of the present invention resulted in decrease in the outside oven temperature of 56° F., which is around a 30% reduction in the loss of heat from the oven. During this testing procedure, it was also noticed that the oven insulated with the insulation jacket reached their peak temperature 20 minutes before a conventionally-insulated oven and the side panels of the oven were 10-15° F. cooler than with the conventionally-insulated oven.

While the preferred method of production of jacket 16 has been disclosed above as vacuum-forming a slurry of high temperature refractory fibers, fillers and binders, jacket 16 may alternatively be formed other ways. A first such alternative method is through the use of a refractory castable slurry, i.e., forming the jacket shape to fill the cavity either by pouring the castable slurry into the oven cavity or into a mold that resembles the shape of the cavity and allowing the same to set. A second method may be utilizing a high-temperature foam to form the shape of the external surface of the baking oven muffle.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention are an example and the invention is not limited to the exact details shown or described.

1. An insulation jacket for use in a baking oven, said jacket comprising:
a unitary-formed insulating member having:
a top wall;
a bottom wall;
a pair of opposing side walls extending between the top and bottom walls;
a rear wall extending between the top, bottom and side walls; wherein said top, bottom, side and rear walls are substantially continuous with each other and are free of joints; and said top, bottom, side and rear walls define and surround an interior cavity that is adapted to receive an oven muffle therein.

2. The insulation jacket as defined in claim 1, wherein the insulating member is comprised of a combination of high temperature refractory fibers and binders.

3. The insulation jacket as defined in claim 2, wherein the fibers are selected from the group consisting of one or more of high-temperature refractory ceramic and fibers comprising oxides of aluminum, silicon, calcium and magnesium.

4. The insulation jacket as defined in claim 2, wherein the binders comprise one or more of organic and inorganic binders.

5. The insulation jacket as defined in claim 4, wherein the organic binders are selected from the group consisting of one or more of cationic starch, cationic polymers and polymeric resins of phenol-formaldehyde.

6. The insulation jacket as defined in claim 4, wherein the inorganic binders are selected from the group consisting of one or more of colloidal silica or colloidal alumina.

7. The insulation jacket as defined in claim 2, wherein the insulating member further includes a filler material selected from the group consisting of one or more oxides of aluminum, silicon, calcium and magnesium that have particle sizes passing through a 30 mesh sieve.

8. The insulation jacket as defined in claim 1, wherein all of the top, bottom, side and rear walls of the insulating member are between ¼ inch and 2 inches thick.

9. The insulation jacket as defined in claim 8, wherein the top, bottom, side and rear walls of the insulating member are all 1 inch thick.

10. The insulation jacket as defined in claim 1, wherein the insulating member defines at least one opening in one of the top, bottom, side and rear walls; said opening being adapted to receive a component that extends outwardly from the oven muffle therethrough.

11. The insulation jacket as defined in claim 1, wherein the unitary-formed insulating member is complementary sized and shaped to tightly fit around an exterior surface of the oven muffle.

12. A baking oven comprising:
an oven muffle having an exterior surface and defining an interior cavity adapted to receive articles to be heated therein;
a unitary-formed insulation jacket having a top wall, a bottom wall, opposing side walls and a rear wall that are substantially continuous with each other and are free of joints therebetween; wherein said top, bottom, side and rear walls define and surround an interior cavity that is complementary shaped and sized to receive the oven muffle therein;
a housing that defines an interior cavity therein; said interior cavity of the housing being complementary shaped and sized to receive the insulation jacket therein; and
a door affixed to one of the muffle and housing to selectively close off access to the interior cavity of the oven muffle.

13. The baking oven as defined in claim 12, wherein the insulation jacket is comprised of a combination of high temperature refractory fibers and binders.

14. The backing oven as defined in claim 13, wherein the fibers in the insulation jacket are selected from the group consisting of one or more of high-temperature refractory ceramic and fibers comprising oxides of aluminum, silicon, calcium and magnesium.

15. The backing oven as defined in claim 13, wherein the binders comprise one or more of organic and inorganic binders.

16. The backing oven as defined in claim 15, wherein the organic binders are selected from the group consisting of one or more of cationic starch, cationic polymers and polymeric resins of phenol-formaldehyde.

17. The backing oven as defined in claim 15, wherein the inorganic binders are selected from the group consisting of one or more of colloidal silica or colloidal alumina.

18. The backing oven as defined in claim 13, wherein the insulation jacket further includes a filler material selected from the group consisting of one or more oxides of aluminum, silicon, calcium and magnesium that have particle sizes passing through a 30 mesh sieve.

19. The baking oven as defined in claim 12, wherein the top, bottom, side and rear walls of the insulation jacket are all between ¼ inch and 2 inches thick.

20. A method of insulating an exterior surface of a baking oven muffle, said method comprising the steps of:
forming a unitary insulation jacket having a top wall, a bottom wall, opposing side walls and a rear wall that surround and define an interior cavity therein; wherein the top, bottom, side and rear walls are substantially continuous with each other and free of joints; and wherein the interior cavity is sized to receive the baking oven muffle therein;
slidingly engaging the insulation jacket over an external surface of the baking oven muffle such that the top, bottom, sides and rear wall of the jacket are aligned with a top wall, bottom wall, side walls and rear wall of the backing oven muffle.
